(19) United States
(12) Patent Application Publication
(10) Pub. No.: US 2002/0159849 A1
(43) Pub. Date: Oct. 31, 2002

(54) Drills and their manufacture

(76) Inventors: Howard Longden, Sheffield (GB); Stewart John Hawley, Sheffield (GB); Isobel Erica Williams, Doncaster (GB)

Correspondence Address: LARSON & TAYLOR, PLC, 1199 NORTH FAIRFAX STREET, SUITE 900, ALEXANDRIA, VA, 22314, US

(21) Appl. No.: 09/899,998

(22) Filed: Jul. 9, 2001

(30) Foreign Application Priority Data
Jul. 10, 2000 (GB) 0016943.3

(51) Int. Cl. B23B 51/00

(52) U.S. Cl. 408/199; 76/108.6

(57) ABSTRACT

A method of producing a fluted drill in which the flutes are formed by grinding a generally cylindrical blank using a grinding wheel having a profiled circumferential face for generating the cross-sectional form of the flutes is characterized in that the radial cross-section of the profiled circumferential face of the grinding wheel includes a main cutting portion having a convexly curved profile, and a secondary cutting portion forming a continuation of the main cutting portion, there being a change in profile shape at the junction between the main and secondary cutting portions with the secondary cutting portion extending outwardly, away from the extended curve of the main cutting portion profile, to a radially outermost peak of the circumferential face.

### BACKGROUND OF THE INVENTION

This invention relates to fluted drills and their production.

### BACKGROUND ART

Conventional twist drills are provided with two or more helical flutes, the leading edges of which at the drill point form the drill forward cutting edges. The flutes extend around a central axial core of the drill body, and at the drill point the end of the central core is shaped to a chisel edge extending from the drill axis to each flute.

The chisel edge is not an efficient cutting edge and it contributes considerably to the cutting effort when a hole is drilled subjected to high loads. It is therefore known to alleviate this disadvantage by giving the bottom of each flute an additional shaping at the drill point, so as to reduce the core diameter there, either eliminating or shortening the chisel edge.

To extend the life of a drill, it is customary to grind back the drill point when the cutting edges have become worn and the additional shaping to thin the core at the drill point must then be reapplied. Apart from the additional work that involves, the regrinding operation is often performed by the user who may not have the skill or the specialised tooling employed in the initial manufacture of the drill, so it is not then possible to reproduce the thinning of the core to the same standard.

In one known method of producing fluted drills, the flutes are formed by grinding using a grinding wheel rotating about an axis oblique to the drill axis, the circumferential face of the grinding wheel forming the flute while the wheel and drill blank undergo a relative movement having components axially of the drill and rotationally about the drill axis. By suitable profiling of the wheel circumferential face, each flute can be cut to its finished cross-sectional shape with a single pass of the grinding wheel.

### SUMMARY OF THE INVENTION

According to one aspect of the invention, there is provided a method of producing a fluted drill in which the flutes are formed by grinding a generally cylindrical blank using a grinding wheel having a profiled circumferential face for generating the cross-sectional form of the flutes, characterised in that the radial cross-section of the profiled circumferential face of the grinding wheel includes a main cutting portion having a convexly curved profile, and a secondary cutting portion forming a continuation of the main cutting portion, there being a change in profile shape at the junction between the main and secondary cutting portions with the secondary cutting portion extending outwardly, away from the extended curve of the main cutting portion profile, to a radially outermost peak of the circumferential face.

By suitable formation of the secondary cutting portion, it has been found possible to introduce a concavity into the flute profile at the same time as the main flute is itself formed, so as to reduce the minimum diameter of the core between the flutes without additional manufacturing operations. Because the thinning is produced by the grinding wheel concurrently with the formation of the flutes, that thinning is continued along the length of the flutes.

To illustrate this, if a conventional grinding wheel having a convexly profiled, typically constant radius, circumferential face to cut the drill flute, were to be modified in accordance with the present invention, material would have to be added to the profile at the apex of the wheel. Theoretically, all that is needed is an infinitely thin protrusion extending radially outwardly from the apex, but this is of course something that is not achievable in practice. Instead, the curvature of the cutting portion is abruptly modified at a point towards the apex to continue outwardly, away from the conventional line of the profile, to a radially outermost peak, protruding radially beyond the point it would be if in the conventional profile.

In one preferred form, the grinding wheel of the invention has a radial cross-section in which a concavely shaped secondary cutting portion of the profile extends from the main cutting portion of said profile and protrudes to the radially outermost peak of the circumferential face. In this case, the inversion of the profile from convex to concave provides the abrupt junction referred to above.

In a more preferred form, the secondary cutting portion of the profile takes the form of a straight edge extending from the main cutting portion. The straight edge may meet the main cutting portion of the profile at an oblique angle, but more preferably extends at a tangent to its junction with the main cutting portion. This profile shape gives the desired “thinning” of the drill core without sacrificing the good strength and resistance to wear of the conventional grinding wheel profiles.

According to a further aspect of the present invention, a drill is provided having a body formed with a plurality of flutes extending from the cutting tip of the drill body, with a central core region between the flutes at the cutting tip being formed with at least one chisel edge, each flute having along its length a uniform profile in cross-section normal to the central axis of the drill, said profile having, between radially outer end portions, a central concave region having an oblique junction with at least one said end portion, a chisel edge or edges at the cutting tip extending between said central concave regions of each flute and the central axis of the drill.

Introducing a central concave region into the flute profile results in thinning the drill core uniformly along the flutes. It is thus possible to regrind the drill and maintain the thinning at the point without additional regrinding operations beyond resharpening the cutting edges.

Preferably, the thinning of the drill core created by the central concave region in the flute profile is such that the inscribed diameter of the core is not substantially less than 8% of the drill outside diameter.

One radially outer end portion of each flute profile will, at the cutting tip, form a cutting edge, the cutting edges usually being equispaced about the axis of the drill, a typical drill having two diametrically opposed cutting edges. Each cutting edge preferably has a positive rake angle. It is also preferred that the rake angle of the flute recess at the transition between the cutting edge is positive, or at least not negative. This can ensure that at least a portion of the recess, at the cutting tip, can serve as a secondary cutting edge.

### BRIEF DESCRIPTION OF THE DRAWINGS

FIG. 1 is a side view of a drill produced in accordance with the invention,

FIG. 2 is a cross-section on the plane A-A in FIG. 1, but to a larger scale,

FIG. 3 illustrates schematically the process by which the flutes of the drill of FIG. 1 are formed in a cylindrical blank by grinding,

FIG. 4 is a detail view of the circled region of the grinding wheel in FIG. 3 showing to a larger scale the circumferential face profile, and

FIG. 5 shows an alternative circumferential face profile with which flutes of similar shape to those of the drill of FIG. 1 can be cut.

### DESCRIPTION OF THE PREFERRED EMBODIMENTS

The drill 2 of FIG. 1 has two diametrically opposed helical flutes 4 extending from its point 6 where the central core of the drill between the flutes is given a chisel edge 8 on its forward face, extending between the flutes 4 in a conventional manner. The outer region of the leading or cutting face 10 of each flute extending about 60% of the radius from the outer periphery has a conventional profile with the outermost portion 10a at a positive rake angle. Similarly, the outer region of the heel or trailing face 12 of each flute has a conventional profile.

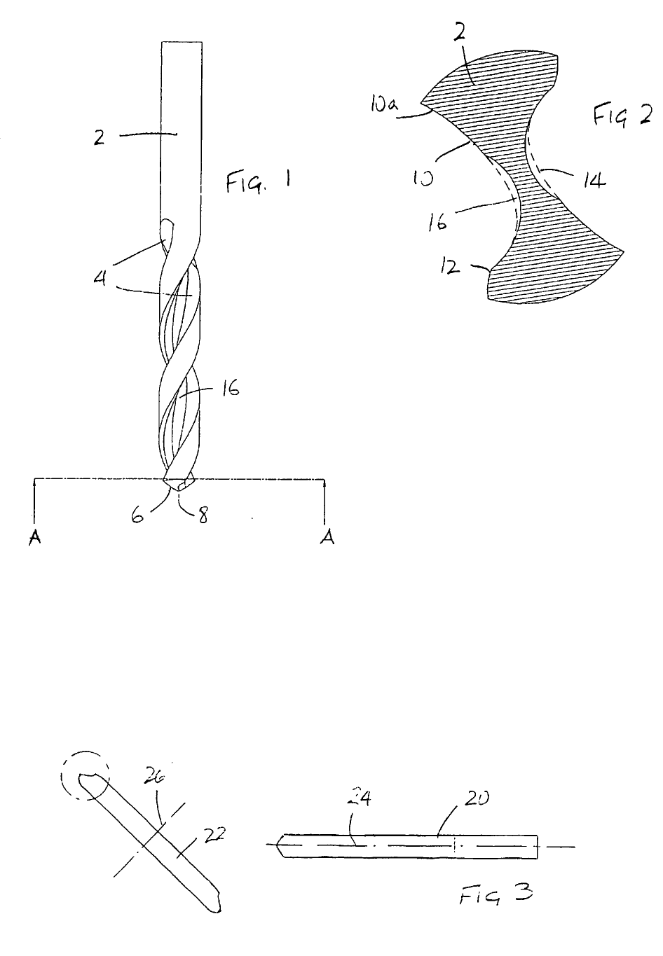

The conventional profile 14 of the central region between these two radially outer regions 10,12 is indicated in broken lines in FIG. 2. However, in the present drill, between these outer regions, a concave recess 16 is formed in each flute, with a profile which blends with the outer region of the trailing face 12. The recess reduces the core diameter and correspondingly the length of the chisel edge between the flutes at the drill point. In use, therefore, the drill is subjected to less resistance as it cuts a hole, so that the power required is reduced and the drill life can be increased. In the illustrated example, the core diameter is 8.5% of the drill outer diameter. This compares with an unmodified core diameter that is 13% of the drill diameter in the example shown.

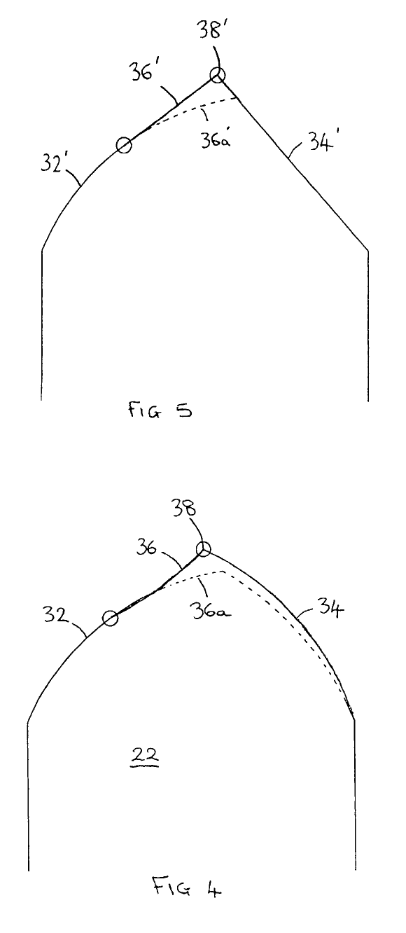

It is known to form each flute of a twist drill, starting from a cylindrical blank 20, with a single pass of a grinding wheel 22 having a profiled outer peripheral face. As indicated in FIG. 3, the wheel rotary axis 26 is set oblique to the drill axis 24 and relative movements are generated between the blank 20 and the grinding wheel 22 both translationally in the direction of the drill axis and rotationally about that axis to give a resultant helical motion between the blank and the wheel defining the flute path.

The profile of the outer peripheral face of the grinding wheel 22, and the orientation of the wheel 22 relative to the blank 20, determine the cross-sectional profile of the flute in this process. As shown in FIG. 4, the profile comprises a convex cutting face 32 at the forward side region of the outer peripheral face of the wheel as well as an auxiliary cutting face 34 at the side of the wheel remote from the main cutting face, the latter forming the protruding outer portion of the flute heel 12.

The previously known profile is however now modified by the addition of a secondary cutting face 36, which extends from the main cutting face 32 in a concave curve to the apex 38 of the wheel 22. FIG. 4 shows in broken lines at 36a the constant radius convex portion of the known grinding wheel profile that has been replaced by the secondary cutting face 36. The effect of the modified secondary cutting face 36 is to change the flute profile so that the concave recess 16 is now generated at the same time as the main profile—ie in a single pass of the grinding wheel.

The profile of the peripheral cutting face of the wheel 22 can be formed in the conventional manner using a cam (not shown) for controlling a wheel dressing tool, in this case with a modified profile to give the secondary cutting face.

FIG. 5 shows an example of an alternative grinding wheel profile that can give the desired concave recess 16 in the drill flute. As in the previous example, the circumferential face comprises a convexly shaped main cutting face 32′ and an auxiliary cutting face 34′. In this example, rather than being concave, the secondary cutting face 36′ extends in a straight line at a tangent to the main cutting face 32′ to a sharp peak at the apex 38′ of the wheel. In FIG. 5, as in FIG. 4, the known grinding wheel profile is shown as a broken line at 36a′.

Forming the flutes 4 in the manner described allows the drills to be produced at a manufacturing cost essentially the same as that of a conventional twist drill. The user has the benefit of a reduced core thickness that extends the length of the flutes so that there is no need to thin the drill point by additional grinding each time the drill is resharpened. The regrinding process is therefore simpler and quicker and requires less skill, as well as resulting in a potentially significant cost saving.

What we claim and desire to secure by Letters Patent:

1. A method of producing a fluted drill in which the flutes are formed by grinding a generally cylindrical blank using a grinding wheel having a profiled circumferential face for generating the cross-sectional form of the flutes, characterised in that the radial cross-section of the profiled circumferential face of the grinding wheel includes a main cutting portion having a convexly curved profile, and a secondary cutting portion forming a continuation of the main cutting portion, there being a change in profile shape at the junction between the main and secondary cutting portions with the secondary cutting portion extending outwardly, away from the extended curve of the main cutting portion profile, to a radially outermost peak of the circumferential face.

2. A method according to claim 1, wherein said main cutting portion of said radial cross-section of the circumferential face of the grinding wheel is of a constant radius.

3. A method according to claim 1, wherein the secondary cutting portion of said radial cross-section of the circumferential face of the grinding wheel is concavely shaped.

4. A method according to claim 1, wherein the secondary cutting portion of said radial cross-section of the circumferential face of the grinding wheel takes the form of a straight edge extending from the main cutting portion.

5. A method according to claim 4, wherein said straight edge meets the main cutting portion at an oblique angle.

6. A method according to claim 4, wherein said straight edge extends at a tangent to its junction with the main cutting portion.

7. A drill produced according to the method of claim 1 and comprising a body having a cutting tip, a plurality of flutes formed in the body to extend from the cutting tip of the drill body to define a central core region between the flutes, at least one chisel edge being formed on the central core region at the cutting tip, each flute having along its length a uniform profile in cross-section normal to the central axis of the drill, said profile having, between radially outer end portions thereof, a central concave region having an oblique junction with at least one said end portion, the chisel edge or edges at the cutting tip extending between said central concave regions of each flute and the central axis of the drill.

8. A drill according to claim 7, wherein the thinning of the drill core created by the central concave region in the profile of the flute is such that the inscribed diameter of the core is not substantially less than 8% of the outside diameter of the drill.

9. A drill according to claim 7, wherein one radially outer end portion of each flute profile forms, at the cutting tip, a cutting edge, the cutting edges being equispaced about the axis of the drill.

10. A drill according to claim 7, wherein one radially outer end portion of each flute profile forms, at the cutting tip, a cutting edge, each cutting edge having a positive rake angle.

11. A drill according to claim 7, wherein the rake angle of the flute profile is not negative, whereby at least a portion of the profile, at the cutting tip, can serve as a secondary cutting edge.
